(19) United States
(12) Patent Application Publication
(10) Pub. No.: US 2019/0122670 A1
(43) Pub. Date: Apr. 25, 2019

(54) SECURE VOICE BIOMETRIC AUTHENTICATION

(71) Applicant: Cirrus Logic International Semiconductor Ltd., Edinburgh (GB)

(72) Inventors: Ryan ROBERTS, Hertfordshire (GB); Michael PAGE, Stonehouse Gloucestershire (GB)

(73) Assignee: Cirrus Logic International Semiconductor Ltd., Edinburgh (GB)

(21) Appl. No.: 16/164,434

(22) Filed: Oct. 18, 2018

Related U.S. Application Data
(60) Provisional application No. 62/575,007, filed on Oct. 20, 2017.

(30) Foreign Application Priority Data
Feb. 9, 2018 (GB) 1802193.1

(51) Int. Cl. G10L 17/22; G10L 17/06; G10L 17/00; H04L 9/32

(52) U.S. Cl. CPC G10L 17/22; H04L 9/3231; G10L 17/005; G10L 17/06

(57) ABSTRACT

One aspect provides a method in an audio data transmission module. The method comprises: obtaining an audio data stream comprising speech from a user to be authenticated, the audio data stream comprising a plurality of data segments; obtaining a voice biometric authentication result relating to the speech in one or more first data segments of the audio data stream; generating data-authentication data for one or more second data segments of the audio data stream; generating one or more cryptographically signed packets comprising the voice biometric authentication result and the data-authentication data; and outputting the one or more cryptographically signed packets.

### TECHNICAL FIELD

Embodiments of the present disclosure relate to voice biometric authentication, and particularly to methods and apparatus for improving the security of a voice biometric authentication process used in the approval of a restricted action.

### BACKGROUND

Voice user interfaces are provided to allow a user to interact with a system using their voice. One advantage of this, for example in devices such as smartphones, tablet computers and the like, is that it allows the user to operate the device in a hands-free manner.

In one typical system, the user wakes the voice user interface from a low-power standby mode by speaking a trigger phrase, potentially followed by one or more command phrases. Speech recognition techniques are used to detect that the trigger phrase has been spoken and to identify the actions that have been requested in the one or more command phrases.

Biometric techniques are increasingly being applied to increase the security of users' interactions with electronic devices. For example, in the context of the voice user interface described above, a speaker recognition process may be performed on the trigger phrase (and potentially also the command phrase(s)) to determine whether the requesting party (i.e. the speaker) is an authorised user of the device or not. The speaker recognition process may be carried out independently of, and parallel to the speech recognition process.

Depending on the outcome of the speaker recognition process, and the level of security applied in the voice user interface, the electronic device may perform, or be prevented from performing one or more restricted actions. For example, if the speaker recognition process fails (e.g. the speaker is not an authorised user), the electronic device may not wake, or become unlocked, in response to detection of the trigger phrase. In further examples, one or more actions requested in the command phrase(s) may not be carried out if the speaker recognition process fails.

The voice user interface may be subject to attack from nefarious third parties seeking to spoof the speaker recognition process and gain access to the restricted actions without the authorised user's approval. One such method of attack is expected to be a “man in the middle” attack, whereby data passing between modules or circuits within an electronic device is intercepted and/or replaced by spoof data, e.g. through the installation of malware on the processing circuitry of the device. For example, in the context of user speech comprising a trigger phrase followed by one or more command phrases, a third party may seek to replace the spoken command phrase with one or more alternative commands which are to the third party's advantage (e.g. a financial instruction transferring funds to the third party, etc). If the speaker recognition process is successful in respect of the trigger phrase (i.e. the speaker is authenticated as an authorised user), the electronic device may carry out actions corresponding to the replacement command phrases, rather than those command phrases actually spoken by the user.

Embodiments of the disclosure seek to address these and other issues.

### SUMMARY

In one aspect there is provided a method in an audio data transmission module. The method comprises: obtaining an audio data stream comprising speech from a user to be authenticated, the audio data stream comprising a plurality of data segments; obtaining a voice biometric authentication result relating to the speech in one or more first data segments of the audio data stream; generating data-authentication data for one or more second data segments of the audio data stream; generating one or more cryptographically signed packets comprising the voice biometric authentication result and the data-authentication data; and outputting the one or more cryptographically signed packets.

In another aspect there is provided an audio transmission device comprising: a first input for obtaining an audio data stream relating to speech from a user to be authenticated, the audio data stream comprising a plurality of data segments; a second input for obtaining a voice biometric authentication result relating to the speech in one or more first data segments of the audio data stream; a data-authentication module configured to generate data-authentication data for one or more second data segments of the audio data stream; a cryptographic module configured to generate one or more cryptographically signed packets comprising the voice biometric authentication result and the data-authentication data; and an output for outputting the one or more cryptographically signed packets.

A further aspect of the disclosure provides a method in an audio data reception module. The method comprises: receiving, from an audio data transmission module, an audio data stream relating to speech from a user requesting biometric authentication, the audio data stream comprising a plurality of data segments; receiving, from the audio data transmission module, one or more cryptographically signed packets comprising: a voice biometric authentication result relating to the speech; and data-authentication data for one or more data segments of the audio data stream; generating data-authentication data for the one or more data segments in the received audio data stream; comparing the generated data-authentication data to the received data-authentication data; and based on the comparison, determining whether to authenticate the user as an authorised user.

Another aspect provides an audio reception module comprising: a first input for receiving, from an audio data transmission module, an audio data stream relating to speech from a user requesting biometric authentication, the audio data stream comprising a plurality of data segments; a second input for receiving, from the audio data transmission module, one or more cryptographically signed packets comprising: a voice biometric authentication result relating to the speech; and data-authentication data for one or more data segments of the audio data stream; a data-authentication module for generating data-authentication data for the one or more data segments in the received audio data stream; and a user-authentication module for comparing the generated data-authentication data to the received data-authentication data and, based on the comparison, determining whether to authenticate the user as an authorised user.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an electronic device according to embodiments of the disclosure;

FIG. 2 shows an audio transmission device according to embodiments of the disclosure;

FIG. 3 shows an audio reception device according to embodiments of the disclosure; and

FIGS. 4a, 4b, 4c and 4d are schematic diagrams shows the processing of an audio data stream according to embodiments of the disclosure.

### DETAILED DESCRIPTION

For clarity, it will be noted here that this description refers to speaker recognition and to speech recognition, which are intended to have different meanings. Speaker recognition refers to a technique that provides information about the identity of a person speaking. For example, speaker recognition may determine the identity of a speaker, from amongst a group of previously registered individuals, or may provide information indicating whether a speaker is or is not a particular individual, for the purposes of identification or authentication. Speech recognition refers to a technique for determining the content and/or the meaning of what is spoken, rather than recognising the person speaking.

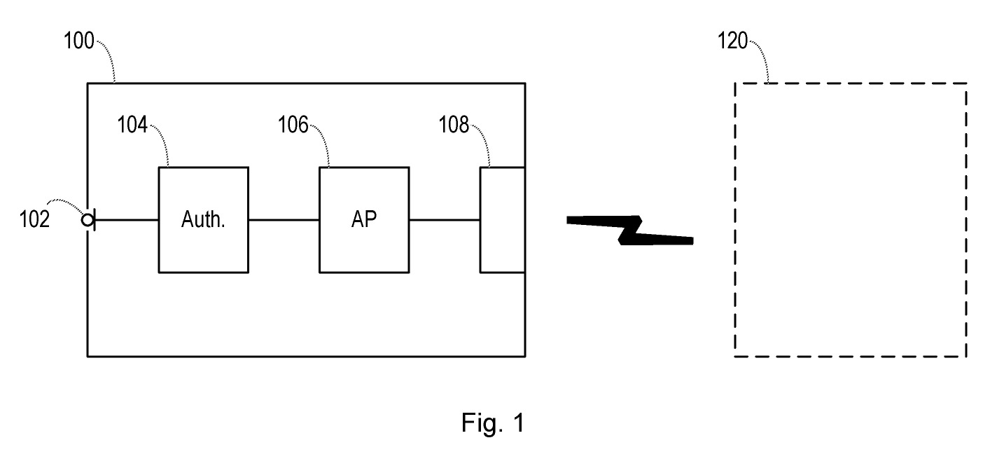

FIG. 1 shows an electronic device 100 in accordance with one aspect of the disclosure. The device may be any suitable type of device, such as a mobile computing device for example a laptop or tablet computer, a games console, a remote control device, a home automation controller or a domestic appliance including a domestic temperature or lighting control system, a toy, a machine such as a robot, an audio player, a video player, or the like, but in this illustrative example the device is a mobile telephone, and specifically a smartphone 100. The smartphone 100 may, by suitable software, be used as the control interface for controlling a further device or system.

The device 100 comprises one or more microphones 102 operable to detect the voice of a user. The microphones 102 are coupled to an authentication device 104, which in turn is coupled to processing circuitry 106. In the illustrated embodiment and the discussion below, the processing circuitry 106 is described as an applications processor (AP). In general, the processing circuitry 106 may be any suitable processor (such as a central processing unit (CPU)) or processing circuitry.

In use, a user speaks into the microphone(s) 102, where the speech is detected, and an audio data stream is generated which comprises the speech. The audio data stream is output to the authentication device 104, which may be implemented as a separate integrated circuit. Here it is noted that the audio data stream output by the microphone(s) 102 may be digital or analogue. In the latter case, the authentication device 104 may comprise an analogue-to-digital converter (ADC) which converts the audio data stream into the digital domain.

The authentication device 104 comprises a voice biometric authentication module or processor, which performs a speaker recognition process on the audio data stream to determine whether or not the speech in the audio data stream corresponds to that of an authorised user. Speaker recognition processes are well known in the art, and will not be described in significant detail herein. Speaker recognition may comprise the extraction of one or more features from the audio data stream (suitable examples include mel frequency cepstral coefficients, perceptual linear prediction coefficients, linear predictive coding coefficients, deep neural network-based parameters, i-vectors, etc), and the comparison of those extracted features to one or more corresponding features in the stored “voiceprint” for an authorised user. The output of the speaker recognition process may be a biometric authentication score, indicating the likelihood that the speaker is an authorised user. In order to determine whether the speaker is an authorised user, the biometric authentication score may be compared to one or more thresholds (either in the authentication device 104 or an external device). A favourable comparison with the threshold(s) may result in positive identification of the speaker as the authorised user; an unfavourable comparison with the threshold(s) may result in a determination that the speaker is not an authorised user, or an indeterminate result that the speaker is neither identified as an authorised user, nor positively ruled out as an authorised user. In the latter case, the user may be asked to provide further speech input to improve the accuracy of the speaker recognition process.

The authentication device 104 may therefore output a biometric authentication result (which may comprise the biometric authentication score, an indication as to whether the speaker is an authorised user or not, or both) to the AP 106. It will further be apparent that the audio data stream itself should be output from the authentication device 104 to the AP 106. For example, a speech recognition process may be implemented outside the authentication device 104, either in the AP 106 or a remote server, requiring that the speech be passed through the authentication device 104 to the AP 106. In many other user cases (i.e. not requiring speaker recognition), the microphone signal is required to be passed to the AP 106. For example, where the device 100 is a mobile phone, the speaker's voice is required to be passed to the AP 106 (or other processing circuitry) for onward transmission during a call.

Similarly, the AP 106 may need to output signals to the authentication device 104. For example, the AP 106 may output control signals to the authentication device 104 to initiate a biometric process (such as authentication, enrolment, etc), or to configure the authentication device 104 for certain modes of operation.

The interface between the authentication device 104 and the AP 106 may thus allow the transmission of signals (control and/or data) in either direction.

The device 100 also comprises interface circuitry 108, providing a wired or wireless interface to external devices for the transmission and reception of data. For example, the interface circuitry 108 may comprise one or more wired interfaces (e.g., USB, Ethernet, etc) and/or one or more wireless interfaces (e.g. implementing a radio link to a cellular communications network, a wireless local area network, etc). In the latter case, the interface circuitry 108 may comprise transceiver circuitry coupled to one or more antennas suitable for the generation or reception of radio signals.

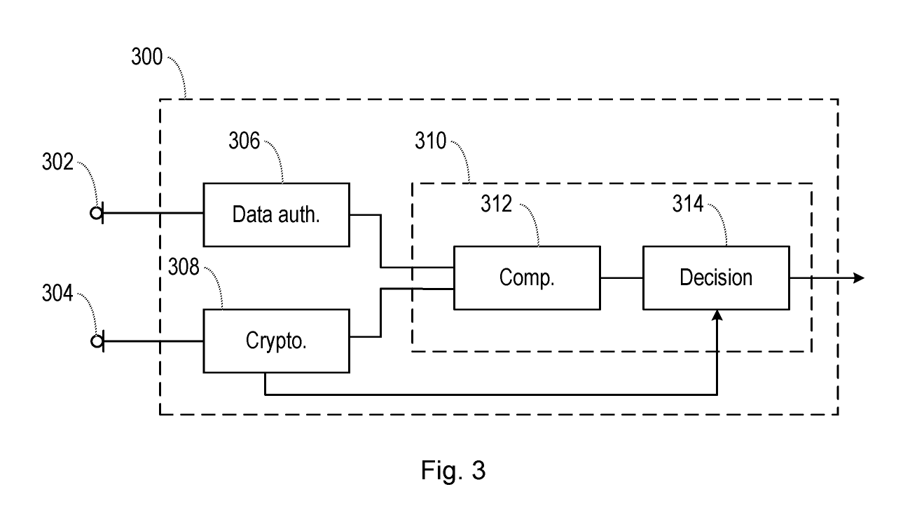

FIG. 1 further shows an external device 120, which is in communication with the electronic device 100 (e.g. via the interface circuitry 108). In some embodiments of the disclosure, the external device 120 may comprise a remote server, implementing a speech recognition process. Thus, in such embodiments the external device receives an audio data stream from the device 100, and processes the data stream to determine the content and/or meaning of the speech comprised within the audio data stream. The contents and/or meaning of the speech may then be transmitted back to the device 100 for further processing. In other embodiments of the disclosure, the external device 120 may additionally or alternatively comprise a remote server implementing an audio reception module. Further detail regarding this aspect is provided below with respect to FIG. 3.

As noted above, one problem that has been identified with devices as illustrated schematically in FIG. 1 is that the interface between the authentication device 104 and the AP 106 is vulnerable to “man-in-the-middle” attacks by third parties seeking to spoof, hijack or otherwise subvert the speaker recognition process carried out in the authentication device 104. For example, in the context of user speech comprising a trigger phrase followed by one or more command phrases, a man-in-the-middle attack may replace the spoken command phrase with one or more alternative commands which are to the third party's advantage (e.g. a financial instruction transferring funds to the third party, etc). Thus the positive biometric authentication result output from the authentication device 104 to the AP 106 may result in the alternative commands being carried out in the AP 106 or the external device 120, rather than the command actually spoken by the user.

The biometric authentication result output from the authentication device 104 may be subject to public-key cryptographic authentication, to prevent the result from being subject to man-in the-middle security attacks. Such cryptographic authentication techniques are computationally intensive, but feasible in this case as the data content of the results message is relatively small. However, the data content of the audio data stream is too large to apply cryptographic authentication without introducing unacceptable increases in latency.

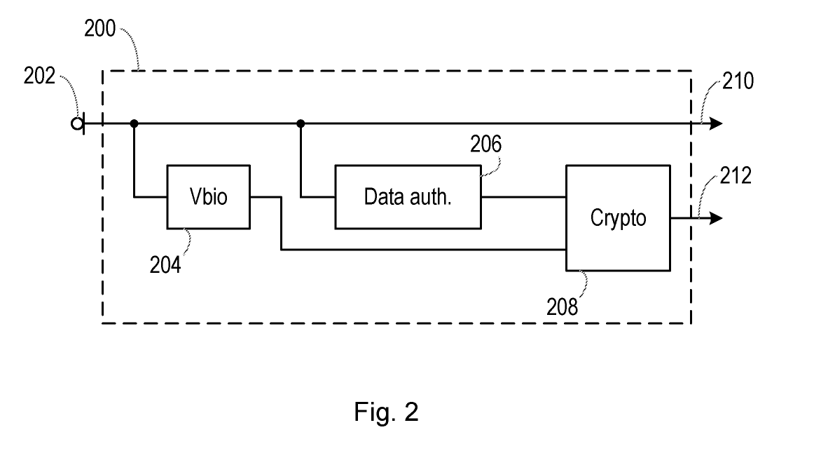

FIG. 2 is a schematic diagram showing an audio transmission device (or module) 200 according to embodiments of the disclosure. The audio transmission device 200 may be implemented in the authentication device 104 described above with respect to FIG. 1, for example.

The audio transmission device 200 is coupled to receive, at an input, an audio data stream from one or more microphones 202 (which may be the same as the microphones 102 described above with respect to FIG. 1). Thus, when a user speaks into the microphone(s) 202, the audio data stream comprises the speech or utterance spoken by the user and detected by the microphone(s) 202.

In the illustrated embodiment, the audio transmission device 200 comprises a voice biometric authentication module 204 (Vbio), which is coupled to receive the audio data stream, and is configured to perform a biometric authentication algorithm on the audio data stream to determine if the speech in the audio data stream belongs to an authorised user or not. As noted above, speaker recognition processes are well known in the art, and the present disclosure is not limited in that respect. As noted above, the output of the biometric authentication module 204 is a biometric authentication result, which may comprise a biometric authentication score, an indication as to whether the user is an authorised user, or both.

It will further be understood by those skilled in the art that the audio data stream may be subject to one or more digital signal processing techniques prior to its input to the biometric authentication module 204. For example, noise cancellation may be utilized to reduce the level of noise in the audio data stream, and so improve the performance of the speaker recognition process. Filtering may be applied to the audio data stream to suppress frequencies which are not of interest to the speaker recognition process, or to emphasize frequencies which are of interest to the speaker recognition process, etc.

The audio transmission device 200 further comprises a data-authentication module or device 206. The data-authentication module 206 is coupled to receive the audio data stream, and configured to generate data-authentication data based on the audio data stream. In this context, data-authentication data is any data which may be used to authenticate the audio data stream (or part of the audio data stream), and which occupies less data than the audio data on which it is based.

In one example, the data-authentication data comprises a hash of part of the audio data stream, such as one or more data blocks or segments (where each data block or segment comprises one or more data samples). The data-authentication device 206 may therefore implement a hashing function, which maps data from the audio data stream to a smaller, fixed-size data structure. Any suitable hashing function may be utilized, such as any of the secure hashing algorithms (e.g. SHA-0, SHA-1, SHA-2, SHA-3 etc). In one particular example, the hashing function may be SHA-256; however, the present disclosure is not limited in that respect.

In another example, the data-authentication data comprises an acoustic fingerprint, i.e. values for one or more parameters characterizing the acoustic signals comprised within the audio data stream. Examples of parameters which may form part of the acoustic fingerprint include: average zero crossing rate; average spectrum; spectral flatness; prominent tones in one or more frequency bands; the positions of peaks in a time-frequency representation in the audio data; signal power; and signal envelope. Additionally or alternatively, the acoustic fingerprint may comprise a rate of change of any of these parameters. The acoustic fingerprint may further comprise an indication of audio phoneme classes in the speech, e.g. a classifier or classifiers for sibilants, vowels, or plosives, speech recognition transcription, etc.

The data-authentication data may further comprise one or more indications of a start point and an end point defining the parts of the audio data stream on which the data-authentication data is based. The start point and end point may be defined using any suitable methodology. For example, each data sample in the audio data stream may be associated with a time stamp, or a count value, in which case the start point and end point may be defined with reference to the time stamp or count value. Additionally or alternatively, data samples may be grouped into data blocks, segments or frames having a fixed or variable number of data samples. The start point and end point may be defined by reference to the data block, segment or frame. In yet further embodiments, the data may be indicated by a start point and a duration, instead of a start point and an end point.

The biometric authentication result and the data-authentication data are output to a cryptographic device or module 208, which generates one or more cryptographically signed data packets comprising the biometric authentication result and the data-authentication data. That is, in one embodiment a cryptographic signature is applied to both the biometric authentication result and the data-authentication data in combination, such that the output is a cryptographically signed data packet comprising both the data-authentication data and the biometric authentication result. In other embodiments, a cryptographic signature may be applied to the biometric authentication result and the data-authentication data separately, such that two cryptographically signed data packets are output.

Cryptographic signatures are known in the art. For example, the audio transmission device 200 may have an associated private-public cryptographic key pair, with the public key of that pair being provided to connected devices (such as the AP 106) during an initial handshake process. In cryptographically signing the data in this way, the cryptographic device 208 may apply the private cryptographic key of that key pair to the combination of the data-authentication data and the biometric authentication result. Alternatively, the cryptographic module 208 may apply a cryptographic key which is shared secretly with the receiving device (in this case the AP or audio reception module 300, see below).

In the illustration, the audio data stream is output from the audio transmission device 200 via a first output 210, while the one or more cryptographically signed packets are output via a second output 212. It will be understood, however, that these outputs 210, 212 may be implemented in a single data interface.

FIG. 2 thus shows an audio transmission device 200 according to some embodiments of the disclosure. Various alterations may be made to the illustrated embodiments without departing from the scope of the claims appended hereto, however. For example, FIG. 2 shows a biometric authentication module 204 within the audio transmission device 200. In alternative embodiments, the biometric authentication module 204 may be implemented outside the audio transmission device 200 (e.g. in a separate integrated circuit), such that the biometric authentication result is received at an input of the audio transmission device.

FIG. 3 shows an audio reception device 300 according to further embodiments of the disclosure. The audio reception device 300 may be implemented in any device which receives an audio data stream and one or more cryptographically signed packets from the audio transmission device 200 described above with respect to FIG. 2.

Thus, in one embodiment the audio reception device 300 is implemented in the AP 106 described above with respect to FIG. 1. By implementing the audio reception device 300 described below, the AP 106 is thus able to determine that the audio data stream and the biometric authentication result are authentic, and duly to authorise the user as an authorised user or otherwise carry out one or more restricted actions. In alternative embodiments, the audio reception device 300 may be implemented in the external device 120 described above with respect to FIG. 1. In such embodiments, the audio data stream and the one or more cryptographically signed packets are output from the AP 106 and from the device 100 (e.g., via the interface circuitry 108). The external device 120 thus receives the audio data stream and the cryptographically signed packets indirectly, but is nonetheless able to determine that the biometric authentication result and the associated audio data stream are authentic.

The audio reception device 300 receives the audio data stream at a first input 302, and the one or more cryptographically signed packets at a second input 304. Although illustrated separately in FIG. 3, it will again be understood that the first and second inputs 302, 304 may be implemented in a single data interface.

The audio data stream is input to a data-authentication device or module 306. The data-authentication module 306 is configured to generate data-authentication data based on the audio data stream. In particular, the data-authentication module 306 may be configured to perform the same algorithm as was performed in the data-authentication module 206 in the audio transmission device 200. Thus, the algorithm may comprise a hashing function, or an acoustic fingerprinting algorithm for example.

The one or more cryptographically signed packets are input to a cryptographic verification device or module 308. The cryptographic verification device 308 processes the data packets, and particularly verifies whether the packets are signed by a cryptographic signature which corresponds to a cryptographic signature associated with the audio transmission device 200. For example, the cryptographic verification device 308 may apply the public key of the private-public key belonging to the audio transmission device 200. Alternatively, the cryptographic verification device 308 may apply a cryptographic key previously shared secretly with the transmitting device (e.g., the authentication device 104 or audio reception module 300).

If the verification device 308 verifies that the cryptographically signed packet originates from the audio transmission device 200 (i.e. the packet or packets are signed with a cryptographic signature which is associated with or matches the cryptographic signature belonging to the audio transmission device 200), the cryptographic device 308 outputs the biometric authentication result and the data-authentication data to a user-authentication device or module 310. The output of data-authentication device 306 is also provided to the user-authentication device 310.

The user-authentication device 310 is operable to determine, based at least on the data-authentication data generated by the device 306, the received data-authentication data output from the cryptographic device 308, and the biometric authentication result, whether or not the user should be authenticated as an authorised user, or whether or not a requested restricted action should be carried out.

The user-authentication device 310 comprises a comparison module, or comparator 312, which compares the received data-authentication data to the generated data-authentication data. If they differ, this is an indication that the audio data stream received by the audio reception device 300 is not the same as the audio data stream processed by the audio transmission device 200, and that the system may have been subject to a man-in-the-middle attack. If they match, this is an indication that the audio data stream received by the audio reception device 300 is the same as the audio data stream processed by the audio transmission device 200, and therefore the audio data stream may be used for further processing.

The comparison module 312 outputs an indication as to whether the data-authentication data match or not to a decision module 314. The decision module 314 also receives the biometric authentication result (e.g. from the cryptographic device 308), and can decide on the basis of those two indications whether or not the user should be authenticated as an authorised user, or whether or not a requested restricted action should be carried out. If the data-authentication data do not match, or if the biometric authentication result is negative, the decision module 314 may determine that the user is not an authorised user, or that the restricted action should not be performed. If the data-authentication data match and the biometric authentication result is positive, the decision module 314 may determine that the user is an authorised user, or that the restriction action should be performed.

It will be understood by those skilled in the art that additional factors may be taken into account in deciding whether or not the user should be authenticated as an authorised user, or whether or not a requested restricted action should be carried out. For example United Kingdom patent application no 1621717.6, assigned to the present Applicant, discloses methods and apparatus in which the routing of signals to the biometric authentication module is taken into account in assessing whether or not a user should be authenticated as an authorised user, or whether or not a requested restricted action should be carried out. In such embodiments, the biometric authentication result may comprise an indication as to whether the routing was secure or insecure. Other methods may seek to determine whether an audio data stream is genuine or computer-generated, for example. The present disclosure is thus not limited to the use of the data-authentication data generated by the device 306, the received data-authentication data output from the cryptographic device 308, and the biometric authentication result in determining whether a user should be authenticated or a restricted action performed.

Similarly, if the verification process in the cryptographic device 308 is negative, the decision module 314 may determine that the user should not be authenticated or a restricted action should not be performed. This may be implemented in a number of ways. For example, the cryptographic device 308 may output a suitable control signal to the decision module 314, or may output no data-authentication data, or no biometric authentication result, or invalid versions of either.

FIGS. 2 and 3 thus show an audio transmission device 200 and a corresponding audio reception device 300. The audio transmission device 200 outputs an audio data stream, and one or more cryptographically signed packets comprising a biometric authentication result and data-authentication data in respect of the audio data stream. In this way, the biometric authentication result is tied in a secure way to the audio data stream, such that the audio data cannot be replaced or altered in a man-in-the-middle attack focussed on the interface between the audio transmission device and the audio reception device.

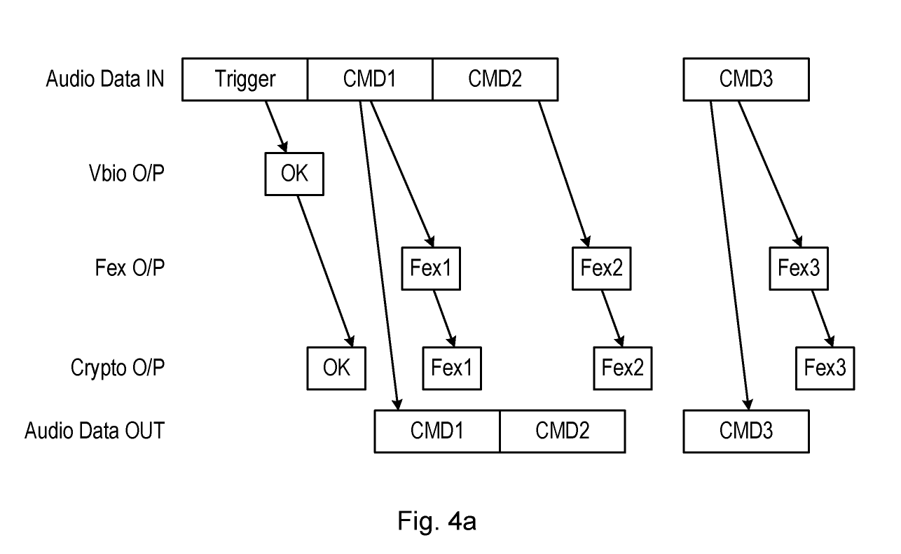

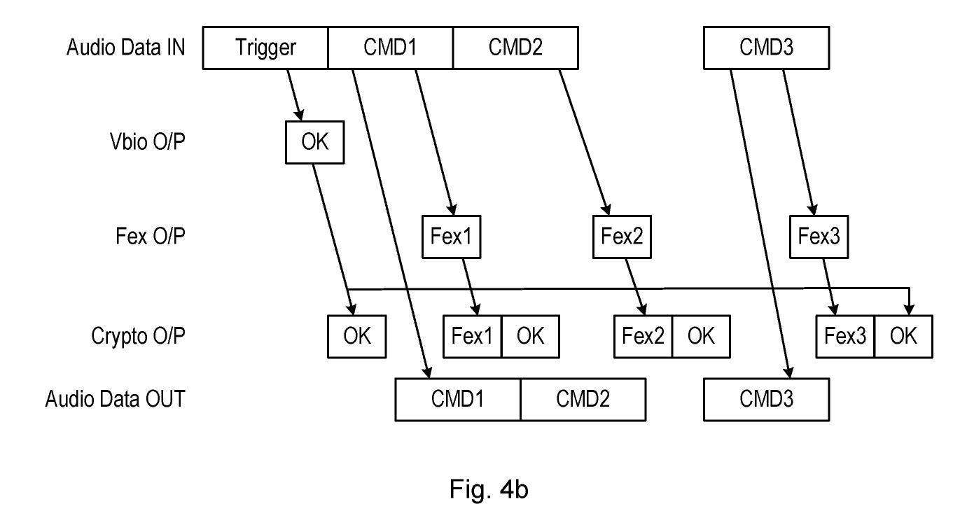

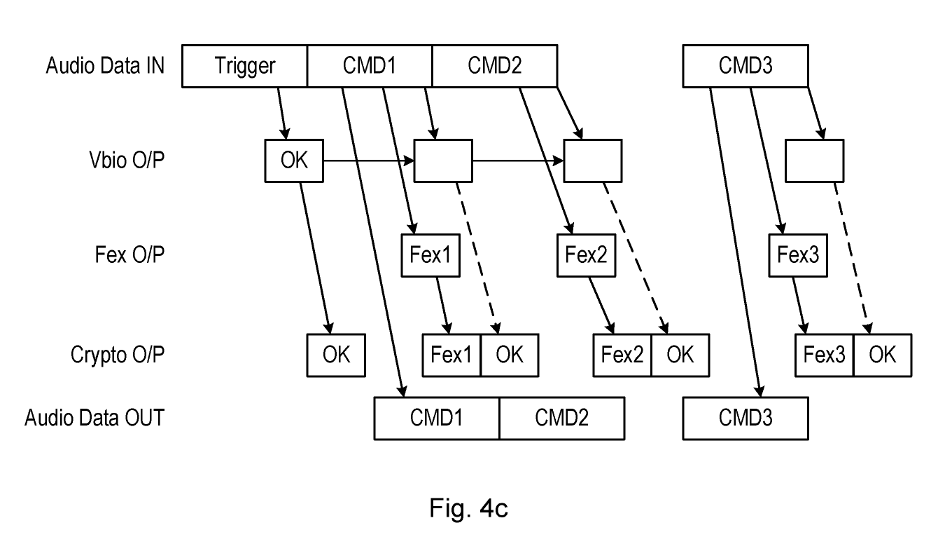

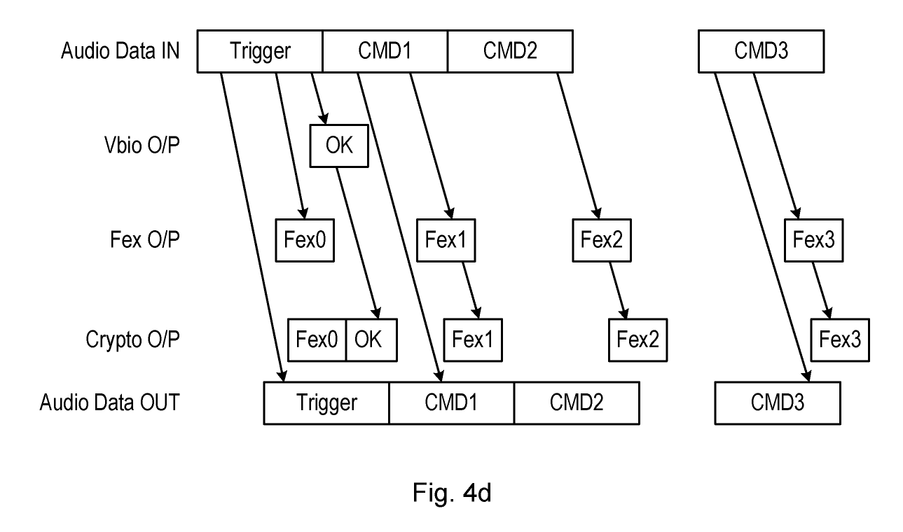

FIGS. 4a, 4b, 4c and 4d show, in schematic form, alternative signal processing of audio data streams according to embodiments of the disclosure. In each case, the audio data stream is segmented into a plurality of data segments, with each data segment comprising one or more data samples. The data segments may correspond to portions of speech in the audio data stream. A first detected portion of speech may be a trigger phrase uttered by the user, i.e. a predefined phrase which can be used to obtain a high level of accuracy in the speaker recognition process. Well-known examples include “Hey Siri”® and “OK Google”®. The trigger phrase may be detected by a low-power voice-activity detect module in the device 100, for example (not illustrated). Subsequent data segments may comprise one or more command phrases which follow the trigger phrase, and contain a request or command for a service to be carried out.

In the examples which follow, the trigger phrase is contained within a single data segment, with subsequent data segments containing command phrase utterances. It will be appreciated that the trigger phrase may be split across one or multiple data segments, while the command phrase may similarly be segmented into one or multiple data segments. Each Figure shows the audio data stream input to the audio transmission device 200: the output of the biometric authentication module 204 (Vbio O/P); the output of the data-authentication module 206 (Fex O/P); the output of the cryptographic module 208 (Crypto O/P); and the audio data stream output from the audio transmission device 200.

In FIG. 4a, the input audio data stream (Audio data in) is split into multiple data segments, comprising a trigger data segment, and three following command data segments. The voice biometric authentication module 204 processes one or more first data segments, which here comprise the trigger data segment, and generates a biometric authentication result (OK). The biometric authentication result is output to the cryptographic device 208, which cryptographically signs it, and the cryptographically signed packet is output from the audio transmission module. Note the latency introduced by the biometric and cryptographic processing.

In this embodiment, the trigger data segment is not output from the audio transmission device 200 to the audio reception device 300. There may be several reasons for this. For example, the trigger phrase (on which the majority of the biometric accuracy is achieved) may be kept from the audio reception device to prevent its being recorded there and later used to spoof the biometric authentication module (e.g. by malware installed on the audio reception device).

A subsequent data segment (CMD 1) is output to the audio reception device 300. Further, data-authentication data is generated in respect of the subsequent data segment CMD 1 (Fex1), and this is cryptographically signed and output from the audio transmission device 200. Subsequent command data segments (CMD 2, CMD 3) are processed similarly.

Thus voice biometric authentication is performed in respect of one or more first data segments (here, the trigger data segment), while data-authentication data is generated in respect of one or more second data segments (here, the command data segments). Further, the biometric authentication result and the data-authentication data are output in separate cryptographically signed packets.

FIG. 4b shows data processing according to an alternative embodiment. The processing corresponds substantially to the processing described above with respect to FIG. 4a. However, in this instance the biometric authentication result generated based on the trigger data segment is output repeatedly for each of the subsequent command data segments. In the illustrated embodiment, the biometric authentication result is combined with respective data-authentication data in a single cryptographically signed packet. In other embodiments, the biometric authentication result may be output in a separate cryptographically signed packet to the data-authentication data.

The processing in FIG. 4c corresponds substantially to the processing in FIG. 4a. However, in this instance the command data segments are used to supplement the speaker recognition process carried out on the trigger phrase. Further detail on this aspect can be found in PCT patent application no PCT/GB2016/051954. Thus the biometric authentication module 204 outputs respective biometric authentication results for each data segment, with each biometric authentication result based on the “current” data segment as well as potentially one or more preceding data segments. Thus, for the nth data segment in the audio data stream, the audio transmission device 200 outputs one or more cryptographically signed packets comprising a biometric authentication result which is based on the nth data segment (as well as potentially one or more preceding data segments such as the (n−1)th data segment, etc) and data-authentication data which is based on the nth data segment, as well as the audio data for the nth data segment.

The processing in FIG. 4d also corresponds substantially to the processing in FIG. 4a. However, in this instance the trigger data segment is output from the audio transmission device 200 in addition to the command data segments which follow.

Thus, according to embodiments of the disclosure, an audio transmission device obtains a biometric authentication result in respect of one or more first data segments of an audio data stream, and data-authentication data in respect of one or more second data segments of the audio data stream. The audio transmission device further generates one or more cryptographically signed packets comprising the biometric authentication result and the data-authentication data. The biometric authentication result and the data-authentication data may be sent in separate cryptographically signed packets (as shown in FIG. 4a, for example), or in the same cryptographically signed packet (as shown in FIG. 4b, 4c or 4d).

One or more cryptographically signed packets may be transmitted for each data segment in the audio data stream. However, the one or more cryptographically signed packets for a particular data segment may not comprise both a biometric authentication result and data-authentication data. For example, as shown in FIG. 4a, a biometric authentication result may be sent in a cryptographically signed packet for one data segment (e.g. a trigger data segment), but not for other data segments (e.g. command data segments). Similarly, data-authentication may be transmitted in a cryptographically signed packet for one data segment (e.g. a command data segment), but not for other data segments (e.g. a trigger data segment). Alternatively, one or more cryptographically signed packets may be transmitted for a particular data segment comprising both the biometric authentication result and the data-authentication data.

The present disclosure thus provides methods, apparatus and computer-readable media which increase the security in electronic devices relying on voice biometric authentication.

The skilled person will thus recognise that some aspects of the above-described apparatus and methods, for example the calculations performed by the processor may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the disclosure will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Embodiments of the disclosure may be arranged as part of an audio processing circuit, for instance an audio circuit which may be provided in a host device. A circuit according to an embodiment of the present disclosure may be implemented as an integrated circuit.

Embodiments may be implemented in a host device, especially a portable and/or battery powered host device such as a mobile telephone, an audio player, a video player, a PDA, a mobile computing platform such as a laptop computer or tablet and/or a games device for example. Embodiments of the disclosure may also be implemented wholly or partially in accessories attachable to a host device, for example in active speakers or headsets or the like. Embodiments may be implemented in other forms of device such as a remote controller device, a toy, a machine such as a robot, a home automation controller or suchlike.

It should be noted that the above-mentioned embodiments illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1. An audio transmission device, comprising:
a first input for obtaining an audio data stream relating to speech from a user to be authenticated, the audio data stream comprising a plurality of data segments;
a second input for obtaining a voice biometric authentication result relating to the speech in one or more first data segments of the audio data stream;
a data-authentication module configured to generate data-authentication data for one or more second data segments of the audio data stream;
a cryptographic module configured to generate one or more cryptographically signed packets comprising the voice biometric authentication result and the data-authentication data; and
an output for outputting the one or more cryptographically signed packets.

2. The audio transmission device according to claim 1, wherein the audio data stream comprises an nth data segment, where n is an integer, and wherein the first input is configured to obtain, for the nth data segment, a voice biometric authentication result relating to speech in the one or more first data segments comprising the nth data segment, and wherein the data-authentication module is configured to generate, for the nth data segment, data authentication for the one or more second data segments comprising the nth data segment.

3. The audio transmission device according to claim 2, wherein the one or more first data segments additionally comprise, for the nth data segment, one or more data segments preceding the nth data segment in the audio data stream.

4. The audio transmission device according to claim 2, wherein the one or more second data segments comprise, for the nth data segment only the nth data segment.

5. The audio transmission device according to claim 1, wherein the cryptographic module is configured to generate one or more cryptographically signed packets in respect of consecutive data segments in the audio data stream.

6. The audio transmission device according to claim 1, wherein the data-authentication data comprises a hash value for the one or more second data segments.

7. The audio transmission device according to claim 1, wherein the data-authentication data comprises an acoustic fingerprint of audio in the one or more second data segments.

8. The audio transmission device according to claim 7, wherein the acoustic fingerprint comprises one or more of: average zero crossing rate; average spectrum; spectral flatness; prominent tones in one or more frequency bands; the positions of peaks in a time-frequency representation in the audio data; signal power; signal envelope; a rate of change of any of the preceding parameters; and audio phoneme classes.

9. The audio transmission device according to claim 1, wherein the one or more cryptographically signed packets further comprise an indication of one or more of a start point and an end point in the audio data stream on which the data-authentication data is based.

10. The audio transmission device according to claim 1, wherein the cryptographic module is configured to generate the one or more cryptographically signed packets by applying a private key of a private-public key pair to one or more of the voice biometric authentication result and the data-authentication data.

11. The audio transmission device according to claim 1, further comprising a second output for outputting at least the one or more second data segments.

12. The audio transmission device according to claim 1, wherein the one or more first data segments relate to a trigger phrase spoken by the user.

13. The audio transmission device according to claim 1, wherein the one or more second data segments relate to a command phrase spoken by the user.

14. The audio transmission device according to claim 1, wherein the cryptographic module is configured to generate a cryptographically signed packet comprising the voice biometric authentication result and the data-authentication data.

15. A method in an audio data transmission module, comprising:
obtaining an audio data stream comprising speech from a user to be authenticated, the audio data stream comprising a plurality of data segments;
obtaining a voice biometric authentication result relating to the speech in one or more first data segments of the audio data stream;
generating data-authentication data for one or more second data segments of the audio data stream;
generating one or more cryptographically signed packets comprising the voice biometric authentication result and the data-authentication data; and
outputting the one or more cryptographically signed packets.

16. A computer program product, comprising a computer-readable tangible medium, and instructions for performing a method according to claim 15.

17. An audio data reception module, comprising:
a first input for receiving, from an audio data transmission module, an audio data stream relating to speech from a user requesting biometric authentication, the audio data stream comprising a plurality of data segments;
a second input for receiving, from the audio data transmission module, one or more cryptographically signed packets comprising:
a voice biometric authentication result relating to the speech; and
data-authentication data for one or more data segments of the audio data stream;
a data-authentication module for generating data-authentication data for the one or more data segments in the received audio data stream; and
a user-authentication module for comparing the generated data-authentication data to the received data-authentication data and, based on the comparison, determining whether to authenticate the user as an authorised user.

18. The audio data reception module according to claim 17, further comprising:
a cryptographic module configured to verify that the one or more cryptographically signed packets are signed with a cryptographic signature which corresponds to a stored signature for the audio data transmission module; and
wherein user-authentication module is further configured to determine whether to authenticate the user as an authorised user based on the verification.

19. The audio data reception module according to claim 18, wherein the cryptographic module is configured to verify by applying to the one or more cryptographically signed packets a public key of a private-public key pair for the audio data transmission module.

20. An electronic device, comprising:
an audio transmission device according to claim 1.

21. An electronic device, comprising:
an audio reception module according to claim 17.
